(19) United States
(12) Patent Application Publication
(10) Pub. No.: US 2009/0092376 A1
(43) Pub. Date: Apr. 9, 2009

(54) VIDEO REPRODUCTION APPARATUS

(76) Inventors: Satoshi Kinoshita, Osaka (JP); Masahiro Nakamori, Osaka (JP); Noriyuki Manabe, Osaka (JP); Katsuki Urano, Osaka (JP); Tomo Kitaguchi, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/298,572

(22) PCT Filed: Apr. 26, 2007
(86) PCT No.: PCT/JP2007/059063

§ 371 Date: Oct. 27, 2008

(30) Foreign Application Priority Data
Apr. 28, 2006 (JP) 2006-126692

(51) Int. Cl. H04N 7/26; H04N 7/12

(52) U.S. Cl. 386/109; 375/240.24; 375/E07.076

(57) ABSTRACT

There is provided a video reproduction apparatus which reduces memory areas for storing video data of decoded bidirectional predictive frames, which apparatus can output the decoded video signals of the entire fields even when all the video signals are outputted by the reproduction in the temporally reverse-direction or the reproduction of searching for arbitrary pictures.

When reproducing the video data in the temporally reverse direction or searching for arbitrary pictures, if display and output are performed from one of the first and second memory areas (201,202) and the decoded video data of two non-bidirectional predictive frames must be stored simultaneously in a third memory area (203) and the other one of the first and second memory areas by the time when the video data to be displayed next is decoded, the currently displayed decoded video data is reduced and stored in the third memory area, and the decoded video data of the two non-bidirectional predictive frames are simultaneously stored in the first and second memory areas while the reduced data is displayed and outputted from the third memory area.

### TECHNICAL FIELD

The present invention relates to a video reproduction apparatus, and more particularly, to a video reproduction apparatus for decoding and reproducing digital data of video or the like which are stored in a DVD (Digital Versatile Disk), an HDD (Hard Disk Drive) or the like.

### BACKGROUND ART

A conventional video reproduction apparatus shown in FIG. 11 is provided with a reading processing block 1101 for reading digital data of video or the like recorded in such as a DVD or an HDD, a decoding processing block 1102 for decoding compressed video data that are read by the reading processing block 1101, a video output processing block 1103 for outputting the decoded video signal, and an external memory 1104 for holding the data to be processed in the reading processing block 1101, the decoding processing block 1102, and the video output processing block 1103. When reproducing the video data recorded in such as a DVD or an HDD, the video data are read by the reading processing block 1101, the read video data are transferred to the decoding processing block 1102 to be decoded, the decoded video signal is input to the video output processing block 1103, and the decoded video signal is outputted from the video output processing block 1103.

The reading processing block 1101, the decoding processing block 1102, and the video output processing block 1103 perform data transfer by DMA transfer with the external memory 1104, respectively, to perform the video reproduction operation. Using the external memory 1104 of a large capacity leads to an increase in the cost of the video reproduction apparatus. So, as a method that can reduce the cost of the video reproduction apparatus, there is proposed a method of reducing the memory area allocated for decoding the video data among the memory areas in the external memory 1104 so as to enable the external memory 1104 of a smaller capacity.

For example, Patent Document 1 proposes as shown in FIG. 15 a method in which, with allocating a frame memory 1204 for storing decoded video data located in an external memory 1205 into respective one frames of a first memory area 1201 and a second memory area 1202, two frames in total, for storing video data obtained by decoding the non-bidirectional predictive frame, and one frame of a third memory 1203 for storing video data obtained by decoding the bidirectional predictive frame, the decoding processing block 1102 and the video output processing block 1103 cooperate with each other, when outputting the decoded video signal using the third memory area 1203 for storing the video data obtained by decoding the bidirectional predictive frame, to perform decoding while outputting the decoded video signal so as not to overwrite the non-outputted decoded video data, thereby reducing the frame memory 1204.

When performing a normal reproduction that outputs pictures in the order of B0, B1, I2, B3, B4, P5 . . . in the conventional video reproduction apparatus as shown in FIG. 7, for example, the decoding of the frame of B3 and outputting thereof are carried out using the third memory area 1203 that stores the video data obtained by decoding the bidirectional predictive frame. At this time, the decoding processing block 1102 performs decoding of the picture B3 up to its middle with referring to the decoded picture data of I2 and P5 which are stored in the first memory area 1201 and the second memory area 1202, respectively, to store the result in the third memory area 1203, while the video output processing block 1103 is outputting the decoded picture data of I2 which is stored in the first memory area 1201. Then, before the third memory area 1203 is filled up, the video output processing block 1103 starts outputting of the decoded picture data of B3 stored in the third memory area 1203, and the decoding processing block 1102 stores the decoded picture data of the remaining portion of B3 into the third memory area 1203 so as to overwrite the decoded picture data which has already been outputted among the decoded picture data of B3 stored in the third memory area 1203. Thereby, the normal reproduction in the video reproduction can be carried out using the memory area of a size less than one frame as the third memory area 1203 for storing the video data obtained by decoding the bidirectional predictive frame.

Patent Document 1: Japanese Published Patent Application No. 2004-343553 (Page 1, FIG. 1)

### DISCLOSURE OF THE INVENTION

### Problems to be Solved by the Invention

As described above, in the conventional video reproduction apparatus, the frame memory 1204 in the external memory 1205 is allocated into the first memory area 1201 and the second memory area 1202 both for storing the video data obtained by decoding the non-bidirectional predictive frame and the third memory area 1203 for storing the video data obtained by decoding the bidirectional predictive frame, and the decoding processing block 1102 and the video output processing block 1103 cooperate with each other, when outputting the decoded video signal using the third memory area 1203 for storing the video data obtained by decoding the bidirectional predictive frame, to perform decoding while outputting the decoded video signal so as not to overwrite the unoutputted decoded video data, whereby the video reproduction can be carried out in the normal reproduction using the memory area of the size less than one frame as the third memory area 1203 for storing the video data obtained by decoding the bidirectional predictive frame.

However, in the case where reproduction in the temporally reverse direction or reproduction of searching for arbitrary pictures should be realized by this method, when the video output processing block is performing display from either of the memories 1201 and 1202 each for one frame for storing the video data obtained by decoding the non-bidirectional predictive frame, a memory area of two frames is required for the decoding of the picture to be outputted next, besides the memory area that is currently displayed.

That is, when performing the reverse-direction reproduction which outputs the pictures in the order of B13, B12, P11, B10, B9, B8, . . . from the state where the decoded picture data of P14 is stored in the first memory area and the decoded picture data of P11 is stored in the second memory area 1202 in the conventional video reproduction apparatus as shown in FIG. 8, B13 and B12 can be decoded with referring to the decoded picture data of P14 and P11 that are stored in the first memory area 1201 and the second memory area 1202, respectively, using the memory area of a size less than one frame as the third memory area 1203 to be outputted as in the normal reproduction, and further, as for the picture data of P11, the decoded picture data of P11 stored in the second memory area can be outputted However, as for B10 to be outputted next, P8 and P11 are required for decoding the same, and P5 is required for decoding P8, and further, I2 is required for decoding P5. Therefore, as shown in the lowermost stage in FIG. 8, I2 is decoded to be stored in the first memory area 1201 in the state where P11 is being outputted, and P5 is decoded with referring to the decoded picture data of I2, and thereby a memory area of one frame is required for the storage of the decoded picture data of P5.

As described above, when realizing the reproduction in the temporally reverse direction or the reproduction of searching for arbitrary pictures in the conventional video reproduction apparatus, when the video output processing block is performing display from either of the memory area 1201 or the memory area 1202, a memory area of two frames may be required for the decoding of the picture to be outputted next, besides the memory area that is currently displayed, resulting in incapability of reducing the memory which is allocated for decoding the video data among the memory areas in the external memory 1104. Alternatively, in the video reproduction apparatus which has reduced the memory allocated for decoding the video data among the memories in the external memory 1104, there is a problem that, when the non-bidirectional predictive frames are decoded and displayed by the reproduction in the temporally reverse direction or the reproduction of searching for arbitrary pictures, the decoded video signals of the entire fields cannot be outputted.

The present invention is made to solve the above-described problems and has for its object to provide a video reproduction apparatus which adopts a scheme in which the decoding processing block and the video output processing block cooperate with each other, when outputting the decoded video signal using a memory area for storing the video data obtained by decoding the bidirectional predictive frame, to perform decoding while outputting the decoded video signal so as not to overwrite the unoutputted decoded video data, thereby reducing the memory area for storing the video data which is obtained by decoding the bidirectional predictive frame, and which can output the decoded video signals of the entire fields even when the non-bidirectional predictive frames are decoded to be displayed by the reproduction in the temporally reverse direction or the reproduction of searching for arbitrary pictures.

### Measures to Solve the Problems

In order to solve the above-described problems, according to claim 1 of the present invention, there is provided a video reproduction apparatus comprising: a decoding block for decoding moving picture coded data which are subjected to a compression processing utilizing an inter-frame correlation in a time-axis direction; a first memory area and a second memory area each of one frame, for storing video data obtained by decoding a non-bidirectional predictive frame; a third memory area of less than one frame, for storing a part of video data obtained by decoding a bidirectional predictive frame; a video output processing block for transferring the video data from any of the first, second, and third memory areas to output the decoded video signal; and a control means for controlling the operations of the decoding block, the first, second, and third memory areas, and the video output processing block; wherein the control means performs, when display and output are being performed from one of the first and second memory areas, and the decoded video data of two non-bidirectional predictive frames should be stored simultaneously in the third memory area as well as in the other one of the first and second memory areas by the time when the video data to be displayed next is decoded when performing reproduction in the temporally reverse direction or when searching for arbitrary pictures, a control such that reduced data which is obtained by reducing the data size of the currently displayed decoded video data so as to fit into the third memory area is stored in the third memory area, and the decoded video data of two non-bidirectional predictive frames are stored simultaneously in the first and second memory areas, as a state where the reduced data is displayed and outputted from the third memory area.

Thereby, in the video reproduction apparatus which adopts a scheme in which the decoding processing block and the video output processing block cooperate with each other, when outputting the decoded video signal using a memory area for storing the video data obtained by decoding the bidirectional predictive frame, to perform decoding while outputting the decoded video signal so as not to overwrite the unoutputted decoded video data, thereby reducing the memory area for storing the video data which is obtained by decoding the bidirectional predictive frame, when outputting all the video signals by the reproduction in the temporally reverse direction or the reproduction of searching for arbitrary pictures, a memory area of two frames for decoding the non-bidirectional predictive frames can be secured, and thereby the decoded video signals of the entire fields can be outputted in the reproduction in the temporally reverse direction or the reproduction of searching for arbitrary pictures.

Further, according to Claim 2 of the present invention, in the video reproduction apparatus defined in Claim 1, the control means performs a control such that, when it is judged that the decoded video data of the non-bidirectional predictive frame can be stored in the third memory area upon a comparison between the data amount which can be stored in the third memory area and the data amount of the decoded video data of the non-bidirectional predictive frame that is to be decoded for decoding the video signal to be displayed next, the decoded video data of two non-bidirectional predictive frames are simultaneously stored in the third memory area and in the other one of the first and second memory areas.

Thereby, the decoded video signals of the entire fields can be outputted in the reproduction in the temporally reverse direction or the reproduction of searching for arbitrary pictures while avoiding reductions in resolution due to an increase in the DMA transfer amount caused by the copying, and due to the size-reduction of the video data.

Further, according to Claim 3 of the present invention, in the video reproduction apparatus defined in Claim 1, the control means performs a control such that, in the processing of storing the reduced data having the reduced data size into the third memory area, the video data in the top or bottom field of the currently displayed decoded video signal is copied into the third memory area, and the memory area from which the decoded video signal is outputted is not switched from the copy source memory area to the copy destination memory area during the copying, and the both fields are displayed in different times.

Thus, the display video switching timing is adjusted to the completion of copying when the copying takes time, and thereby all the decoded video signals can be outputted in the reproduction in the temporally reverse direction or the reproduction of searching for arbitrary pictures while avoiding a reduction in resolution caused by that the previously display video data is repeatedly displayed.

Further, according to Claim 4 of the present invention, in the video reproduction apparatus defined in Claim 1, the control means performs a control such that, when storing the reduced data having the reduced data size into the third memory area, a reduction ratio for reducing the data size of the decoded video data that is currently displayed by the video output processing block to a data size that just fits into the third memory area is obtained, and the data size is reduced by thinning out the decoded video data that is currently displayed by the video output processing block in the horizontal direction, or the vertical direction, or the both directions in accordance with the reduction ratio, or by filtering the decoded video data that is currently displayed by the video output processing block in accordance with the reduction ratio.

Thereby, the decoded video signals of the entire fields can be outputted in the reproduction in the temporally reverse direction or the reproduction of searching for arbitrary pictures, while minimizing a reduction in resolution caused by the reduction in the data size.

Further, according to Claim 5 of the present invention, in the video reproduction apparatus defined in Claim 1, an internal buffer used for the process of storing the reduced data having the reduced data size into the third memory area and an internal buffer used by the video output processing block are commonized.

Thereby, it is not necessary to add a special buffer for the process of storing the reduced data of the reduced data size into the third memory area, and further, the number of times of DMA transfers can be halved because the DMA transfer to the special buffer is dispensed with. As the result, the decoded video signals of the entire fields can be outputted in the reproduction in the temporally reverse direction or the reproduction of searching for arbitrary pictures, while shortening the storage processing time for the reduced data into the third memory area as well as minimizing an increase in the DMA band width.

Further, according to Claim 6 of the present invention, in the video reproduction apparatus defined in Claim 1, the control means performs a control such that the picture data decoded by the decoding block is stored with the data in the top field and the data in the bottom field being separated from each other in the memory area, and performs control such that the address of the memory area that is currently displayed is converted into the address of the third memory area, and the reduced data which is obtained by reducing the data size of the decoded video data that is currently displayed by the video outputting block so as to fit into the third memory area is stored in the third memory area, in order to obtain a state where, when the display field of the currently displayed decoded video data is changed, the address where the head data of the field for which the display is started becomes the head address of the third memory area, and the decoded video data in the field for which the display is started is stored in the third memory area.

Thereby, the decoded video signals of the entire fields can be outputted in the reproduction in the temporally reverse direction or the reproduction of searching for arbitrary pictures, while shortening the storage processing time for the reduced data into the third memory area as well as minimizing an increase in the DMA band width.

Further, according to Claim 7 of the present invention, in the video reproduction apparatus defined in Claim 1, the control means performs a control such that, when the video output processing block displays and outputs the reduced data from the third memory area, when the picture signal outputted by the picture-output processing does not exceed the range of the reduced data stored in the storage processing upon a comparison between the storage speed and the outputting speed of the reduced data into the third memory area, and the amount of the unstored reduced data, the outputting of the decoded video signal is started from the third memory area before the storage of the reduced data into the third memory area is completed.

Thereby, the decoded video signals of the entire fields can be outputted in the reproduction in the temporally reverse direction or the reproduction of searching for arbitrary pictures, while shortening the storage processing time for the reduced data.

Further, according to Claim 8 of the present invention, there is provided a video reproduction apparatus comprising: a decoding block for decoding moving picture coded data which are subjected to a compression processing utilizing an inter-frame correlation in a time-axis direction; a first memory area and a second memory area each of one frame, for storing video data obtained by decoding a non-bidirectional predictive frame; a third memory area of less than one frame, for storing a part of decoded video data; a video output processing block for transferring the video data from any of the first, second, and third memory areas to output a decoded video signal; and a control means for controlling the operations of the decoding block, the first, second, and third memory areas, and the video output processing block; wherein the control means performs a control such that a memory area of one frame is secured by compensating the third memory area with using an audio or sub-video input data buffer area, when performing reproduction in a temporally reverse direction or when searching for arbitrary pictures.

Thereby, in the video reproduction apparatus which adopts a scheme in which the decoding processing block and the video output processing block cooperate with each other, when outputting the decoded video signal using a memory area for storing the video data obtained by decoding the bidirectional predictive frame, to perform decoding while outputting the decoded video signal so as not to overwrite the unoutputted decoded video data, thereby reducing the memory area for storing the video data which is obtained by decoding the bidirectional predictive frame, when outputting all the video signals by the reproduction in the temporally reverse direction or the reproduction of searching for arbitrary pictures, a memory area for decoding the next non-bidirectional predictive frame is secured by compensating the memory area of less than one frame using an unused input buffer for sub-video or audio data, and thereby the decoded video signals of the entire fields can be outputted in the reproduction in the temporally reverse direction or the reproduction of searching for arbitrary pictures.

According to Claim 9 of the present invention, there is provided a video reproduction apparatus comprising: a decoding block for decoding moving picture coded data which are subjected to a compression processing utilizing an inter-frame correlation in a time-axis direction; a first memory area and a second memory area each of one frame, for storing video data obtained by decoding a non-bidirectional predictive frame, respectively; a third memory area of less than one frame, for storing a part of decoded video data; a video output processing block for transferring the video data from any of the first, second, and third memory areas to output a decoded video signal; and a control means for controlling the operations of the decoding block, the first, second, and third memory areas, and the video output processing block; wherein the control means performs a control such that a memory area of one frame is secured by compensating the third memory area with using a part of a main-video input data buffer area, when performing reproduction in a temporally reverse direction or when searching for arbitrary pictures.

Thereby, in the video reproduction apparatus which adopts a scheme in which the decoding processing block and the video output processing block cooperate with each other, when outputting the decoded video signal using a memory area for storing the video data obtained by decoding the bidirectional predictive frame, to perform decoding while outputting the decoded video signal so as not to overwrite the unoutputted decoded video data, thereby reducing the memory area for storing the video data which is obtained by decoding the bidirectional predictive frame, when outputting all the video signals by the reproduction in the temporally reverse direction or the reproduction of searching for arbitrary pictures, a memory area for decoding the next non-bidirectional predictive frame is secured by compensating the memory area of less than one frame using a part of a main-video data input buffer, and thereby the decoded video signals of the entire fields can be outputted in the reproduction in the temporally reverse direction or the reproduction of searching for arbitrary pictures.

Further, according to Claim 10 of the present invention, in the video reproduction apparatus defined in Claim 8 or Claim 9, the control means performs, when a non-bidirectional predictive frame that is temporally previous by one frame is to be decoded in a case where reproduction in the temporally reverse direction or search for arbitrary pictures is performed and the picture that is currently displayed is a non-bidirectional predictive frame, a control such that a memory area which stores the decoded video data of the one-frame-previous non-bidirectional predictive frame is determined according to the total number of the picture to be outputted next and the pictures to be decoded by the time when the picture to be outputted next is decoded, and whether the picture to be outputted next is a bidirectional predictive frame or not.

Thereby, a state where the data required for outputting is not stored in the part of the sub-video, audio, or main-video data input buffer which has compensated the third memory area can be obtained when recovering to the normal reproduction, and thus the recovery can be smoothly performed.

Further, according to Claim 11 of the present invention, in the video reproduction apparatus defined in Claim 8 or Claim 9, the control means performs, when a non-bidirectional predictive frame that is temporally previous by one frame is to be decoded in a case where reproduction in the temporally reverse direction or search for arbitrary pictures is performed and the picture that is currently displayed is a non-bidirectional predictive frame, a control such that the decoded video data of the one-frame-previous non-bidirectional predictive frame is copied from the memory area which stores this data to another memory area.

Thereby, a state where the data required for outputting is not stored in the part of the sub-video, audio, or main-video data input buffer which has compensated the third memory area can be obtained when recovering to the normal reproduction, and thus the recovery can be smoothly performed.

Further, according to Claim 12 of the present invention, in the video reproduction apparatus defined in Claim 9, the control means performs, when recovering to the normal reproduction from the reproduction in the temporally reverse direction or the reproduction of searching for arbitrary pictures, a control such that the input data in the main-video input data buffer area which is used when performing the reproduction in the temporally reverse direction or the reproduction of searching for arbitrary pictures is copied into another area in the input data buffer area.

Thereby, the processing for the input data in the main-video data input buffer which has compensated the third memory area can be easily performed when recovering to the normal reproduction.

### EFFECTS OF THE INVENTION

According to the present invention, in the video reproduction apparatus which adopts a scheme in which the decoding processing block and the video output processing block cooperate with each other, when outputting the decoded video signal using a memory area for storing the video data obtained by decoding the bidirectional predictive frame, to perform decoding while outputting the decoded video signal so as not to overwrite the unoutputted decoded video data, thereby reducing the memory area for storing the video data which is obtained by decoding the bidirectional predictive frame, it is possible to output the decoded video signals of the entire fields by the reproduction in the temporally reverse direction or the reproduction of searching for arbitrary pictures while maintaining the allowable picture quality and data transfer amount.

Thereby, the data in the frame memory can be reduced even in the reproduction in the temporally reverse direction or the reproduction of searching for arbitrary pictures. For example, if the frame memory is 621 KB and x=7, a reduction of 186.3 KB can be achieved.

### BRIEF DESCRIPTION OF THE DRAWINGS

FIG. 1 is a diagram illustrating the construction of a video reproduction apparatus according to first or second embodiment of the present invention.

FIG. 2 is a diagram illustrating the internal construction of a frame memory in an external memory in the video reproduction apparatus according to the first or second embodiment.

FIG. 3 is a diagram illustrating a frame memory control when reproduction is performed in the reverse direction in the video reproduction apparatus of the first embodiment.

FIG. 4 is a diagram illustrating a frame memory control process flow when performing reproduction in the temporally reverse direction or reproduction of searching for arbitrary pictures in the video reproduction apparatus of the first embodiment.

FIG. 5 is a diagram illustrating a frame memory control when reproduction is performed in the reverse direction in the video reproduction apparatus of the second embodiment.

FIG. 6 is a diagram illustrating a frame memory control process flow when performing reproduction in the temporally reverse direction or reproduction of searching for arbitrary pictures in the video reproduction apparatus of the second embodiment.

FIG. 7 is a diagram for explaining the operation of the conventional video reproduction apparatus when performing reproduction in the forward direction.

FIG. 8 is a diagram for explaining the operation of the conventional video reproduction apparatus when performing reproduction in the reverse direction.

FIG. 9 is a diagram for explaining the operation of the video reproduction apparatus of the first embodiment when performing reproduction in the reverse direction.

FIG. 10 is a diagram for explaining the operation of the video reproduction apparatus of the second embodiment when performing reproduction in the reverse direction.

FIG. 11 is a diagram illustrating the construction of the conventional video reproduction apparatus.

FIG. 12 is a diagram illustrating the internal construction of a frame memory in an external memory in the conventional video reproduction apparatus.

### DESCRIPTION OF REFERENCE NUMERALS

101 . . . reading processing block
102 . . . decoding processing block
103 . . . video output processing block
104 . . . external memory
201 . . . memory which stores video data of a decoded non-bidirectional predictive frame (for one frame)
202 . . . memory which stores video data of a decoded bidirectional predictive frame (for one frame)
203 . . . memory which stores video data of a decoded bidirectional predictive frame (for 0.x frame)
204 . . . frame memory

### BEST MODE TO EXECUTE THE INVENTION

Hereinafter, embodiments of the present invention will be described with reference to the drawings.

### Embodiment 1

Hereinafter, a video reproduction apparatus according to a first embodiment of the present invention will be described.

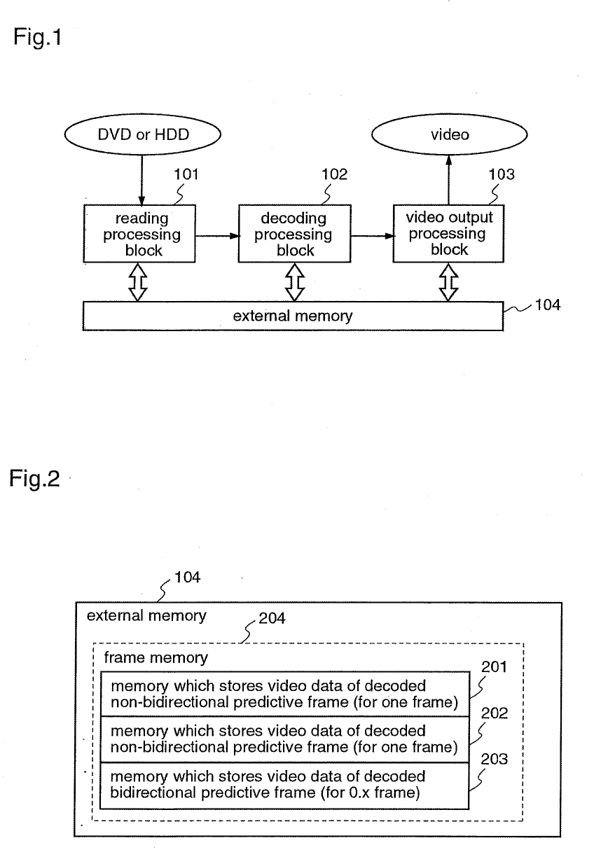

The video reproduction apparatus of the first embodiment shown in FIG. 1 is provided with a reading processing block 101 for reading digital data of video or the like which are recorded on such as a DVD or an HDD, a decoding processing block 102 for decoding compressed video data which are read by the reading processing block 101, a video output processing block 103 for outputting the decoded video signal, and an external memory 104 for storing the data to be processed by the reading processing block 101, the decoding processing block 102, and the video output processing block 103.

FIG. 2 is a diagram illustrating a part of an internal structure of the external memory 104 in the video reproduction apparatus of the first embodiment. A frame memory 204 for storing decoded video data located in the external memory 104 is allocated into respective one frames of a first memory area 201 and a second memory area 202, two frames in total, for storing video data obtained by decoding a non-bidirectional predictive frame, and less than one frame (0.x frame) of a third memory area 203 for storing a part of video data obtained by decoding a bidirectional predictive frame.

Further, the video reproduction apparatus of the first embodiment includes a control means (not shown) which performs a control as follows. That is, when performing reproduction in the temporally reverse direction or when searching for arbitrary pictures, if the video output processing block 103 is performing display from either of the first and second memory areas 201 and 202 and it is judged that it is necessary to store the decoded video data of two non-bidirectional predictive frames simultaneously in the third memory area 203 and in the other one of the first and second memory areas 201 and 202 by the time when the video data to be displayed next is decoded, the reduced data obtained by reducing the data size of the decoded video data that is currently displayed by the video output processing block 103 so as to fit into the third memory area 203 is stored in the third memory area 203, and the decoded video data of the two non-bidirectional predictive frames are simultaneously stored using the first and second memory areas 201 and 202 while the video output processing block 103 displays the reduced data from the third memory area 203.

Next, the operation of the video reproduction apparatus of the first embodiment will be described.

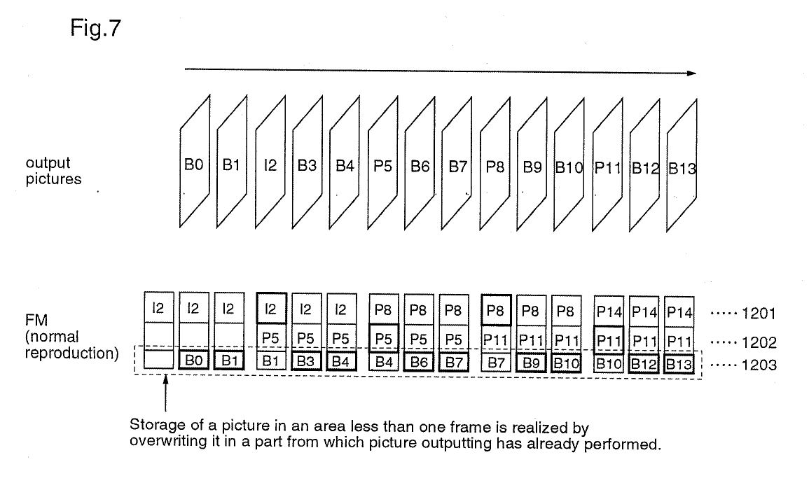

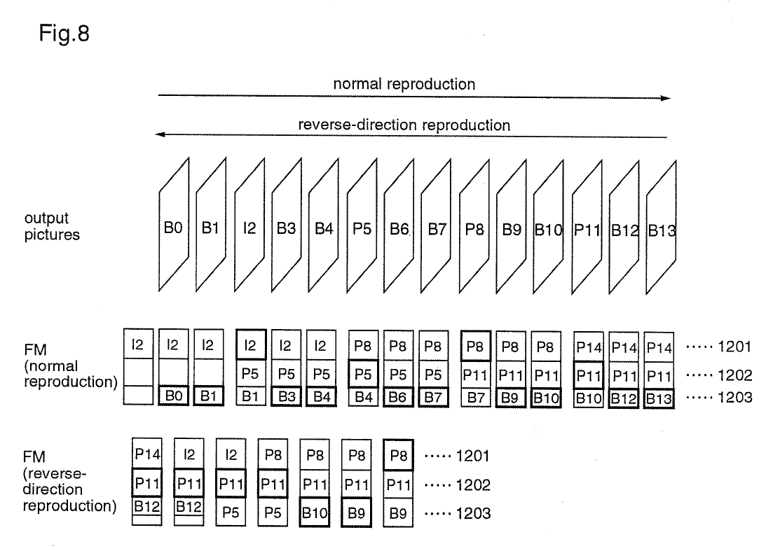

In the video reproduction apparatus of the first embodiment, when performing reproduction in the temporally forward direction, the video reproduction can be carried out using a memory area of a size less than one frame as the third memory area 203 which stores the video data obtained by decoding the bidirectional predictive frame, according to the similar operation as the video reproduction performed by the conventional video reproduction apparatus shown in FIG. 7.

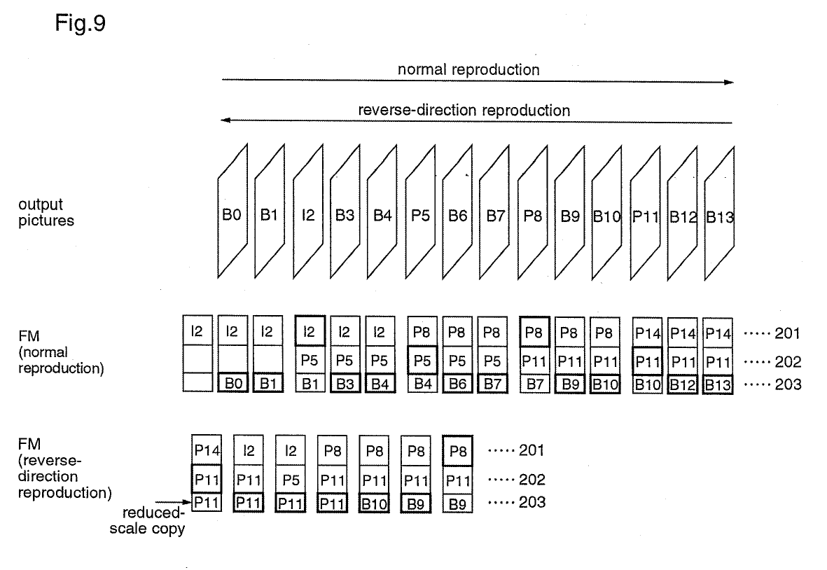

To be specific, as shown in FIG. 9, when performing the normal reproduction which outputs the pictures in the order of B0, B1, I2, B3, B4, P5, . . . , for example, decoding of the frame of B3 and outputting thereof are carried out using the third memory area 203 which stores the video data obtained by decoding the bidirectional predictive frame. At this time, the decoding processing block 102 decodes B3 up to its middle with referring to the decoded picture data of I2 and P5 which are stored in the first memory area 1201 and the second memory area 1202, respectively, to store the result into the third memory area 203, while the video output processing block 103 is outputting the decoded picture data of I2 stored in the first memory area 201. Then, before the third memory area 203 is filled up, the video output processing block 103 starts outputting of the decoded picture data of B3 stored in the third memory area 203, and the decoding processing block 102 stores the decoded picture data of the remaining part of B3 into the third memory area 203 so as to overwrite the already-outputted decoded picture data among the decoded picture data of B3 stored in the third memory area 203. Thereby, the normal reproduction in the video reproduction can be performed using the memory area of a size less than one frame as the third memory area 203 which stores the video data obtained by decoding the bidirectional predictive frame.

On the other hand, when performing reproduction in the temporally reverse direction or searching for arbitrary pictures, since the bidirectional predictive frame and the non-bidirectional predictive frame cannot be decoded unless the decoding is performed from the beginning, it is necessary to secure a memory area of two frames at maximum besides the memory area which stores the decoded video signal being displayed, in order to decode the video signal to be displayed next. However, only a memory for 1+0.x frame can be secured when the decoded video signal is being outputted from either of the first and second memory areas 201 and 202.

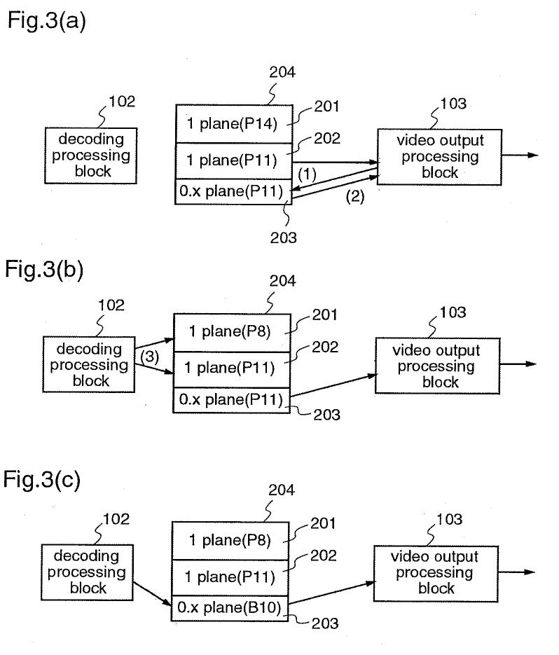

FIG. 3 is a diagram illustrating a control for the decoding processing block 102 and the frame memory 204 in the video output processing block 103 when performing reproduction in the temporally reverse direction in the order of P11, B10, B9, P8 . . . or when searching for arbitrary pictures. Here, the alphabets indicate the picture types, and the numerals indicate the outputting order when the reproduction is performed in the forward direction.

With reference to FIG. 3(a), when the video output processing block 103 outputs P11 in the second memory area 202 in the frame memory 204, P8 and P11 are required for decoding B10 to be outputted next. Further, P5 is required for decoding P8, and 12 is required for decoding P5. To be specific, it is necessary to perform the steps of decoding I2 and storing the decoded video data of I2 in the memory area, decoding P5 with referring to the decoded video data of I2 and storing the decoded video data of P5 in the memory area, and further, decoding P8 with referring to the decoded video data of P5 and storing the decoded video data of P8 in the memory area where the decoded video data of I2 has been stored, and decoding P11 with referring to the decoded video data of P8 and storing the decoded video data of P11 in the memory area where the decoded video data of P5 has been stored, and therefore, it becomes necessary to simultaneously store the decoded video data of two non-bidirectional predictive frames in a memory area other than the memory area which stores the decoded video signal being displayed.

In the video reproduction apparatus of this first embodiment, initially, as shown by (1) in FIG. 3(a), the video output processing block 103 copies the decoded video data of P11 which is stored in the memory 202 that stores video data of a decoded non-bidirectional predictive frame into the third memory area 203 which stores video data of a decoded bidirectional predictive frame, with the data size thereof being reduced, while outputting P11.

The reduction in the data size is performed by obtaining a reduction ratio for reducing the data size of the decoded video data that is currently displayed by the video output processing block 103 to a data size that just fits into the third memory area 203 and then thinning out the decoded video data that is currently displayed by the video output processing block 103 in the horizontal direction, or the vertical direction, or the both directions according to the reduction ratio, or filtering the decoded video data that is currently displayed by the video output processing block 103 according to the reduction ratio. When reducing the data size by the data thinning, if a reduction in resolution caused by that the video data displayed in the past is repeatedly displayed can be allowed, the video data in the top or bottom field of the decoded video signal that is currently displayed by the video output processing block 103 may be copied in the third memory area. In this case, the memory area from which the decoded video signal is outputted is not switched from the copy source memory area to the copy destination memory area during the copying, and the both fields are displayed in different times, whereby the reduction in resolution caused by repetition of the video data displayed in the past can be minimized.

Next, the video output processing block 103 switches the video output from the second memory area 202 to the third memory area 203 as shown by (2) in FIG. 3(a) to secure the first and second memory areas 201 and 202 for decoding.

Then, as shown in the lowermost stage in FIG. 9, I2 is decoded and the decoded video data of I2 is stored in the first memory area 201 where the decoded video data of P14 has been stored, and P5 is decoded with referring to the decoded video data of I2 and the decoded video data of P5 is stored in the second memory area 202 where the decoded video data of P11 has been stored. Further, as shown by (3) in FIG. 3(b), P8 is decoded with referring to the decoded video data of p5 and the decoded video data of P8 is stored in the first memory area 201 where the decoded video data of I2 has been stored, and P11 is decoded with referring to the decoded video data of P8 and the decoded video data of P11 is stored in the second memory area 202 where the decoded video data of P5 has been stored.

Thereafter, as shown in FIG. 3(c), the decoding processing block 102 and the video output processing block 103 cooperate with each other to perform decoding of B10 and outputting thereof with referring to the decoded video data of P8 that is stored in the first memory area 201 and the decoded video data of P11 that is stored in the second memory area 202, while outputting the decoded video signal so as not to overwrite the decoded video data.

In this way, when performing reproduction in the temporally reverse direction or when searching for arbitrary pictures, if it is necessary to store the decoded video data of two non-bidirectional predictive frames simultaneously in the memory area that is not currently used for display among the third memory area and the first and second memory areas by the time when the video data to be displayed next is decoded, the decoded video data that is currently displayed by the video output processing block is reduced and stored in the third memory area to secure the first and second memory areas for decoding, whereby the decoded video signals of the entire fields can be outputted in the reproduction in the temporally reverse direction or the reproduction of searching for arbitrary pictures.

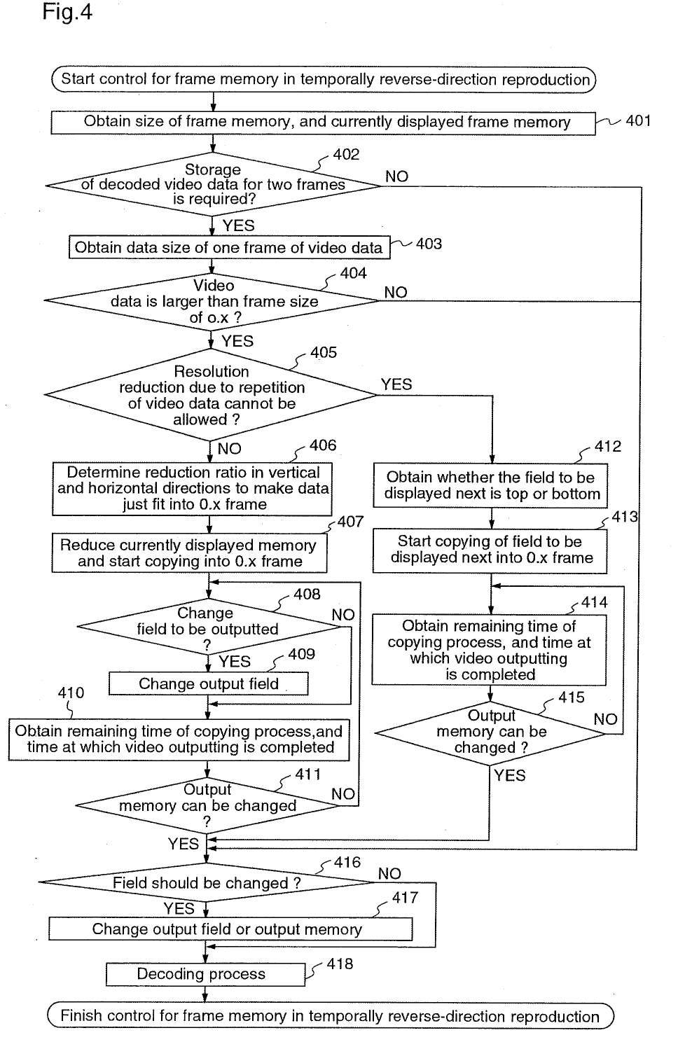

FIG. 4 is a diagram illustrating a specific example of a frame memory control processing flow when performing reproduction in the temporally reverse direction or reproduction of searching for arbitrary pictures in the video reproduction apparatus of this first embodiment. Hereinafter, the frame memory control processing flow when performing reproduction in the temporally reverse direction or reproduction of searching for arbitrary pictures in the video reproduction apparatus of this first embodiment will be described in detail with reference to FIG. 4.

In the flow of FIG. 4, initially, the size of the memory 203 which stores a part of the video data obtained by decoding the bidirectional predictive frame and the information as to which of the memories 201, 202, and 203 is the memory that currently outputs the decoded video signal, are obtained (step S401). However, as for the information that is constant during the stream decoding, it is not always necessary to obtain the same for each frame memory control processing.

When the size of the memory area 203 which stores a part of the video data obtained by decoding the bidirectional predictive frame is less than one frame (0.x frame) and the memory area which currently outputs the decoded video signal is one of the first memory area 201 and the second memory area 202, if it is judged that it is necessary to store the decoded video data of two non-bidirectional predictive frames simultaneously in the third memory area 203 and in the other one of the first and second memory areas 201 and 202 by the time when the video data to be displayed next is decoded, the operation goes to step S403. On the other hand, when it is not necessary to stored the decoded video data of two non-bidirectional predictive frames simultaneously in the third memory area 203 and in the other one of the first and second memory areas 201 and 202 by the time when the video data to be displayed next is decoded, the operation directly goes to step S416 to perform the next decoding (step S402).

In step S403, in order to check whether or not the decoded video data of the frame to be decoded next can be stored in the third memory area 203 having the capacity for 0.x frame, the data size of the decoded video data of the frame to be decoded next is obtained. When the data size of the decoded video data of the frame to be decoded next is larger than the capacity of the third memory area 203, the operation goes to step S405. When the data size of the decoded video data of the frame to be decoded next is equal to or smaller than the capacity of the third memory area 203 and therefore the decoded video data of the frame to be decoded next can be stored in the third memory area 203, the operation directly goes to step S416 to perform the next decoding (step S404).

In step S405, the video data is not outputted at the timing to perform display next, and it is judged whether the reduction in resolution due to the repetition of the video data displayed in the past is allowable or not. When the resolution reduction is not allowable, the operation goes to step S406, and when the resolution reduction is allowable, the flow diverges to the process of copying the top or bottom field, and the operation goes to step S412. In step S406, a reduction ratio for reducing the data size of the decoded video data that is currently displayed by the video output processing block to a data size which just fits into the third memory area 203 is obtained. Thereby, the resolution reduction caused by the reduction in the picture data can be minimized. Thereafter, in step S407, the data size is reduced by thinning out the decoded video data that is currently displayed by the video output processing block 103 in the horizontal direction, or the vertical direction, or the both directions according to the reduction ratio obtained in step S406, or by filtering the decoded video data currently displayed by the video output processing block 103 according to the reduction ratio obtained in step S406, and then storage of the reduced data into the third memory area 203 is started.

In the case of reducing the data size by thinning out the data, the data is made transferable to the third memory area 203 in accordance with the timing when the video output processing block 103 outputs the decoded video signal, and on the other hand, in the case of reducing the data size by the filtering, the data is made transferable to the third memory area 203 using the blanking period during which the video output processing block 103 outputs the decoded video signal, whereby the internal buffer used for the copying and the internal buffer used by the video output processing block 103 can be commonized. By adopting such construction, it is not necessary to add a special internal buffer for the copying, and further, it is also not necessary to perform DMA transfer to the internal buffer for copying from the memory area 201 or 202 from which the decoded video signal is currently outputted.

Subsequently, when changing the output field in step S408, the change of the output field is informed to the video output processing block 103, and the output field is changed in step S409.

Thereafter, the processing time until the copying is completed and the time until the outputting of the decoded video signal is completed are obtained in step S410. When the copying has already been completed or when it is judged that the copying can be completed by the time the outputting of the decoded video signal is completed, it becomes possible to change the output memory in step S411, while the processes in steps S408 to S411 are repeated without outputting the decoded video signal from the third memory area 203 until the change of the output memory becomes possible.

On the other hand, in step S412, it is obtained as to whether the field to be changed next is the top field or the bottom field. Then, in step S413, the field whose decoded video is to be displayed next is copied to the third memory area 203. If the top field and the bottom field can be decoded separately from each other, the field that is currently displayed is stored in the first half part of the second memory area 202, whereby the copying can be omitted by performing the address conversion using the second half part of the second memory area 202 and the third memory area 203 which are combined as a memory for one frame.

Thereafter, in step S414, when the process of obtaining the processing time required until the copying process is completed and the time required until the outputting of the decoded video signal is completed as in step S410 has been completed, or when it is judged that the copying can be completed by the time when the outputting of the decoded video signal is completed, it becomes possible to change the output memory in step S415, while the processes in steps S414 and S415 are repeated without outputting the decoded video signal from the third memory area 203 until the change of the output memory becomes possible.

When it is necessary to change the currently displayed field in step S416, the output field or the output memory is changed in step S417, and the decoding is carried out in step S418. When it is not necessary to change the currently displayed field in step S416, the decoding is carried out in step S418 without changing the output field or the output memory.

As described above, in the video reproduction apparatus of this first embodiment, when performing reproduction in the temporally reverse direction or when searching for arbitrary pictures, if display is performed from one of the first and second memory areas 201 and 202 and it is necessary to store the decoded-video data of two non-bidirectional predictive frames simultaneously into the third memory area 203 and the other one of the both memory areas 201 and 202 by the time when the video data to be displayed next is decoded, the reduced data which is obtained by reducing the data size of the currently displayed decoded video data so as to fit into the third memory area 203 is stored in the third memory area 203, and the decoded video data of two non-bidirectional predictive frames are simultaneously stored in the first and second memory areas 201 and 202 while the reduced data is displayed and outputted from the third memory area 203, and then the video data to be displayed next is decoded. Therefore, in the video reproduction apparatus which adopts a scheme in which the decoding processing block and the video output processing block cooperate with each other, when outputting the decoded video signal using a memory area for storing the video data obtained by decoding the bidirectional predictive frame, to perform decoding while outputting the decoded video signal so as not to overwrite the unoutputted decoded video data, thereby reducing the memory area for storing the video data which is obtained by decoding the bidirectional predictive frame, when outputting all the video signals in the reproduction in the temporally reverse direction or the reproduction of searching for arbitrary pictures, a memory area of two frames for decoding the non-bidirectional predictive frames can be secured, and thereby the decoded video signals of the entire fields can be outputted in the reproduction in the temporally reverse direction or the reproduction of searching for arbitrary pictures.

### Embodiment 2

Hereinafter, a video reproduction apparatus according to a second embodiment of the present invention will be described.

While the video reproduction apparatus of this second embodiment has the same construction as the video reproduction apparatus of the first embodiment shown in FIGS. 1 and 2, it is different from the video reproduction apparatus of the first embodiment in the manner of performing control by a control means (not shown) during the reproduction in the temporally reverse direction or the reproduction of searching for arbitrary pictures.

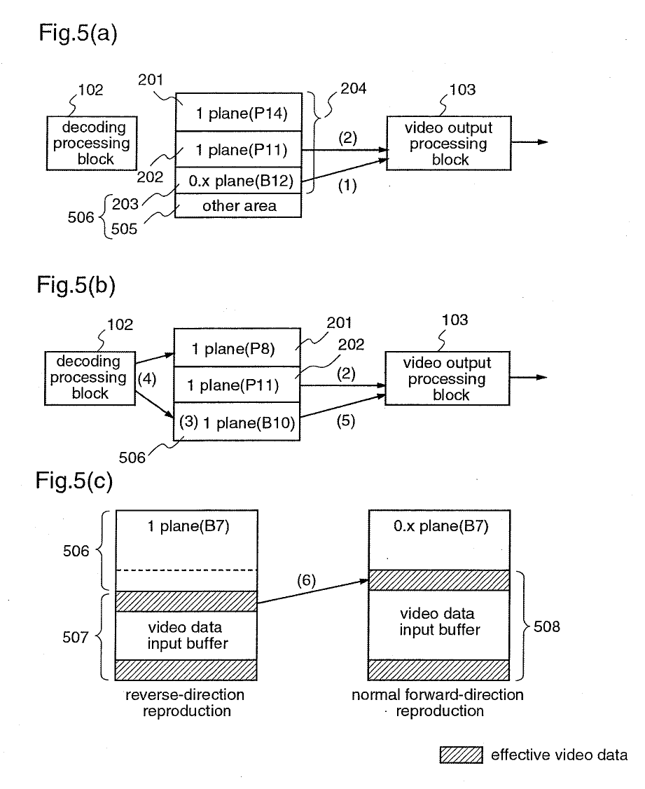

FIG. 5 is a diagram illustrating the control for the external memory 104 by the decoding processing block 102 and the video output processing block 103 when performing the reproduction in the temporally reverse direction in the order of, for example, B12, P11, B10, B9, P8, B7, B6, P5, . . . , or when searching for arbitrary pictures, in the video reproduction apparatus of this second embodiment.

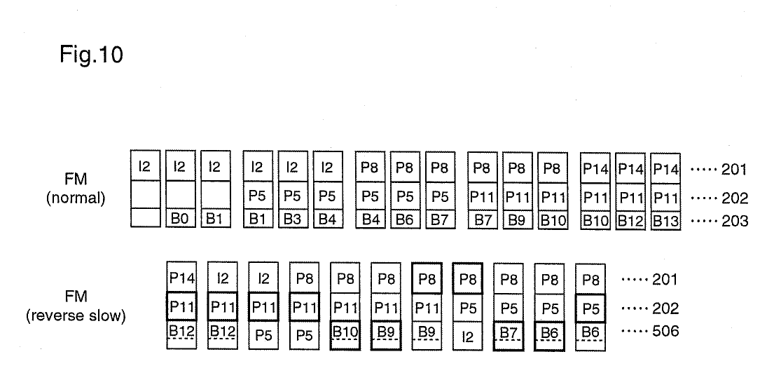

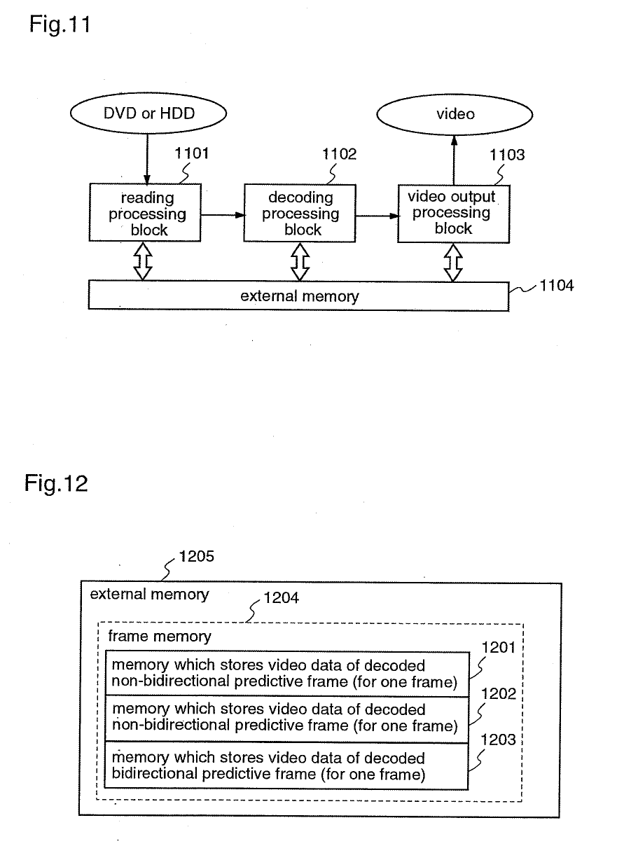

In the video reproduction apparatus of this second embodiment, when performing the reverse-direction reproduction, as shown in FIG. 5(a), an other area 505 serving as an input data buffer for audio or sub-video or main-video in the external memory 104 is added to the 0.x-plane memory area 203 in the frame memory 204, thereby to secure a frame area 506 for one plane. When the video output processing block 103 outputs P11 from the memory area 202 in the frame memory, in order to perform decoding for B10 to be outputted next, the decoding processing block 102 performs decoding of I2,P5,P8 using the memory area 201 and the one-plane frame area 506. The decoding processing block holds the number of I and P pictures to be decoded by the time when B10 is decoded, and controls the location of the memory area which stores the decoded video data so that the decoded data of B10 can be stored in the frame area 506. If the control has failed and B10 is placed in a memory area other than the frame area 506, the decoded data of B10 is copied into the frame area 506. That is, as shown in the lower stage in FIG. 10, I2 is decoded and the decoded video data thereof is stored in the first memory area 201 where the decoded video data of P14 has been stored, and P5 is decoded with referring to the decoded video data of I2 and the decoded video data thereof is stored in the frame area 506 for one plane. Further, as shown by (4) in FIG. 5(b), P8 is decoded with referring to the decoded video data of P5 and the decoded video data of P8 is stored in the first memory area 201 where the decoded video data of I2 has been stored, and B10 is decoded with referring to the decoded video data of P8 and the decoded video data of P11, and the decoded video data of B10 is stored in the frame area 506 where the decoded video data of P5 has been stored, and simultaneously, outputted to the video output processing block 103 as shown by (5) in FIG. 5(b).

Further, in the video reproduction apparatus of this second embodiment, as shown in FIG. 5(c), in the case where a part of the video data input buffer 507 is used as the other area 505 to be added to the memory area 203, if the data in the video data input buffer 507 that is not used as the other area 505 is wrapped around when recovering from the reverse-direction reproduction to the normal reproduction, the effective video data is copied into the head area in the video data input buffer 508, to which the wrapped-around data returns, so that the data in the video data input buffer 508 after the recovery to the normal reproduction can be continuously processed.

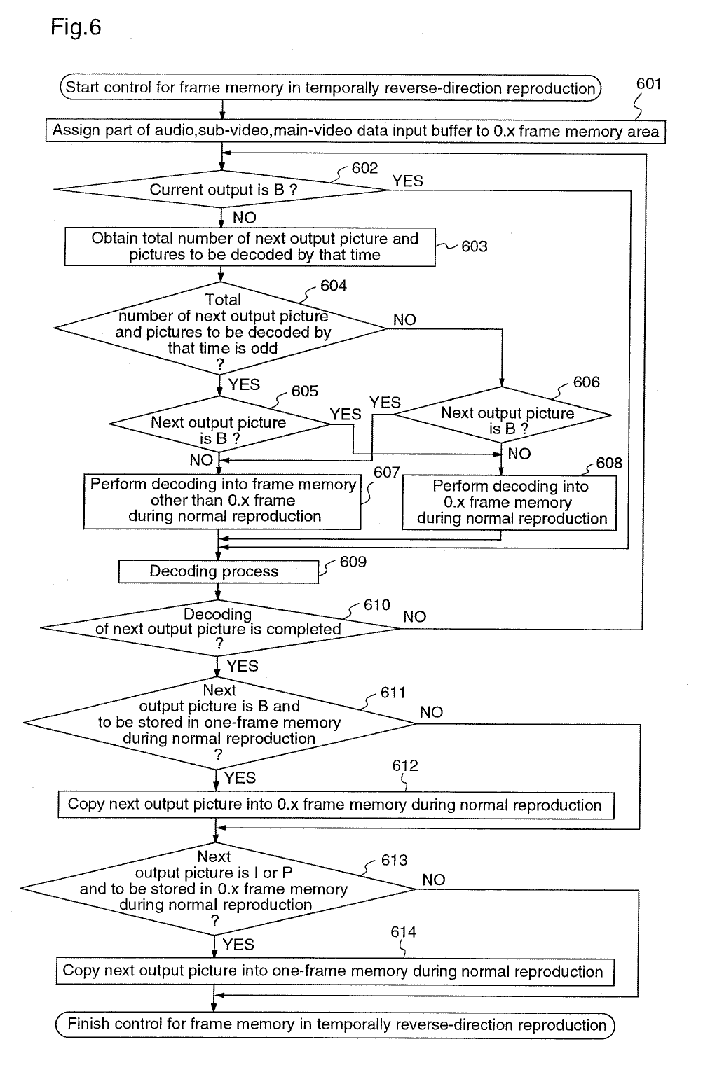

FIG. 6 is a diagram illustrating a specific example of a frame memory control processing flow when performing the reproduction in the temporally reverse direction or the reproduction of searching for arbitrary pictures in the video reproduction apparatus of the second embodiment. Hereinafter, the frame memory control process flow when performing the temporally reverse reproduction or the arbitrary-picture searching reproduction in the video reproduction apparatus of the second embodiment will be described in detail with reference to FIG. 6.

In the flow of FIG. 6, when performing the reproduction in the temporally reverse direction or the reproduction of searching for arbitrary pictures, the audio or sub-video data input buffer area is assigned to the frame memory 204 to secure an area of one plane of frame memory in step S601. If an area of one plane of frame memory cannot be secured even using the audio or sub-video data input buffer area, the third memory area 203 is compensated using a part of the main-video data input buffer to secure an area 506 of one plane.

Then, in step S602, it is judged whether the video that is currently outputted is a bidirectional predictive frame or not, and when it is a bidirectional predictive frame, the operation goes to step S609 to perform the next decoding. When it is not a bidirectional predictive frame, the operation goes to step S603 to perform the process of obtaining the total number of the next output picture and the pictures to be decoded by that time.

Next, in step S604, it is judged whether the total number of the next output picture and the pictures to be decoded by that time is odd or even, and then it is judged whether the next output picture is a bidirectional predictive frame or not in step S605, S606. When the total number of the next output picture and the pictures to be decoded by that time is odd and the next output picture is a bidirectional predictive frame or when the total number is even and the next output picture is not a bidirectional predictive frame, it is set in step S608 to perform decoding into the frame area 506, and otherwise, it is set in step S607 to perform decoding into the first memory area 201 or the second memory area 202 from which data outputting is not currently performed.

Thereby, when the next output picture is a bidirectional predictive frame, the outputting can be performed from the frame area 506, and when it is other than a bidirectional predictive frame, the outputting can be performed from the first memory area 201 or the second memory area 202. When a frame other than a bidirectional predictive frame is stored in the frame area 506 and outputted therefrom by this processing, a part of the frame area 506 is changed to the data input buffer for audio, sub-video, or main-video at the recovery to the normal reproduction, thereby avoiding that the recovery to the normal reproduction cannot, be smoothly performed.

After the decoding in step S609, if the decoding of the next output picture has not yet been completed, the operation returns to step S602 to repeat the steps from S602 to S609. After the decoding in step S609, when the decoding of the next output picture has already been completed, if the next output picture is a bidirectional predictive frame and the memory area wherein the decoded picture data is stored is not the frame area 506, the decoded picture data is copied into the frame area 506 in step S612. Further, if the next output picture is not a bidirectional predictive frame and the memory area where the decoded picture data is stored is the frame area 506, the decoded picture data is copied into a memory area from which no data is currently outputted between the first memory area 201 and the second memory area 202 other than the frame area 506, in step S614. This processing is performed as a countermeasure against errors when the bidirectional predictive frame that is wrongly outputted in the process of step S607 or S608 is stored in a frame area other than the frame area 506 or when a frame that is not the bidirectional predictive frame to be outputted is stored in the frame area 506.

When a part of the main-video data input buffer is used as the frame memory 504 at the recovery to the normal reproduction, if the input data is wrapped around like the video data input buffer 507 during the reverse-direction reproduction shown in FIG. 5, the video data is copied to facilitate the processing for the video data after the recovery to the normal reproduction like the video data input buffer 508 at the recovery to the normal reproduction.

As described above, in the video reproduction apparatus according to the second embodiment, when performing reproduction in the temporally reverse direction or when searching for arbitrary pictures, the third memory area is compensated using the audio or sub-video input data buffer area or a part of the main-video input data buffer area to secure a memory area of one frame, and thereby the video data to be displayed is decoded. Therefore, in the video reproduction apparatus which adopts a scheme in which the decoding processing block and the video output processing block cooperate with each other, when outputting the decoded video signal using a memory area for storing the video data obtained by decoding the bidirectional predictive frame, to perform decoding while outputting the decoded video signal so as not to overwrite the unoutputted decoded video data, thereby reducing the memory area for storing the video data which is obtained by decoding the bidirectional predictive frame, when outputting all the video signals in the reproduction in the temporally reverse direction or the reproduction of searching for arbitrary pictures, the decoded video signals of the entire fields can be outputted in the reproduction in the temporally reverse direction or the reproduction of searching for arbitrary pictures.

### APPLICABILITY IN INDUSTRY

The present invention is effective when applied to a system for reproducing video data recoded on a DVD or an HDD, which uses an external memory of a small capacity. Further, it is also applicable to external recording media.

1. A video reproduction apparatus comprising:
a decoding block for decoding moving picture coded data which are subjected to a compression processing utilizing an inter-frame correlation in a time-axis direction;
a first memory area and a second memory area each of one frame, for storing video data obtained by decoding a non-bidirectional predictive frame;
a third memory area of less than one frame, for storing a part of video data obtained by decoding a bidirectional predictive frame;
a video output processing block for transferring the video data from any of the first, second, and third memory areas to output the decoded video signal; and
a control means for controlling the operations of the decoding block, the first, second, and third memory areas, and the video output processing block; wherein
said control means performs,
when display and output are being performed from one of the first and second memory areas, and the decoded video data of two non-bidirectional predictive frames should be stored simultaneously in the third memory area as well as in the other one of the first and second memory areas by the time when the video data to be displayed next is decoded when performing reproduction in the temporally reverse direction or when searching for arbitrary pictures,
a control such that reduced data which is obtained by reducing the data size of the currently displayed decoded video data so as to fit into the third memory area is stored in the third memory area, and
the decoded video data of two non-bidirectional predictive frames are stored simultaneously in the first and second memory areas, as a state where the reduced data is displayed and outputted from the third memory area.

2. A video reproduction apparatus as defined in claim 1, wherein
said control means performs a control such that, when it is judged that the decoded video data of the non-bidirectional predictive frame can be stored in the third memory area upon a comparison between the data amount which can be stored in the third memory area and the data amount of the decoded video data of the non-bidirectional predictive frame that is to be decoded for decoding the video signal to be displayed next, the decoded video data of two non-bidirectional predictive frames are simultaneously stored in the third memory area and in the other one of the first and second memory areas.

3. A video reproduction apparatus as defined in claim 1, wherein
said control means performs a control such that, in the processing of storing the reduced data having the reduced data size into the third memory area, the video data in the top or bottom field of the currently displayed decoded video signal is copied into the third memory area, and
the memory area from which the decoded video signal is outputted is not switched from the copy source memory area to the copy destination memory area during the copying, and the both fields are displayed in different times.

4. A video reproduction apparatus as defined in claim 1, wherein
said control means performs a control such that, when storing the reduced data having the reduced data size into the third memory area, a reduction ratio for reducing the data size of the decoded video data that is currently displayed by the video output processing block to a data size that just fits into the third memory area is obtained, and
the data size is reduced by thinning out the decoded video data that is currently displayed by the video output processing block in the horizontal direction, or the vertical direction, or the both directions in accordance with the reduction ratio, or by filtering the decoded video data that is currently displayed by the video output processing block in accordance with the reduction ratio.

5. A video reproduction apparatus as defined in claim 1, wherein an internal buffer used for the process of storing the reduced data having the reduced data size into the third memory area and an internal buffer used by the video output processing block are commonized.

6. A video reproduction apparatus as defined in claim 1, wherein
said control means performs a control such that the picture data decoded by the decoding block is stored with the data in the top field and the data in the bottom field being separated from each other in the memory area, and
performs a control such that the address of the memory area that is currently displayed is converted into the address of the third memory area, and the reduced data which is obtained by reducing the data size of the decoded video data that is currently displayed by the video outputting block so as to fit into the third memory area is stored in the third memory area, in order to obtain a state where, when the display field of the currently displayed decoded video data is changed, the address where the head data of the field for which the display is started becomes the head address of the third memory area, and the decoded video data in the field for which the display is started is stored in the third memory area.

7. A video reproduction apparatus as defined in claim 1, wherein
said control means performs a control such that, when the video output processing block displays and outputs the reduced data from the third memory area, when the picture signal outputted by the picture-output processing does not exceed the range of the reduced data stored in the storage processing upon a comparison between the storage speed and the outputting speed of the reduced data into the third memory area, and the amount of the unstored reduced data, the outputting of the decoded video signal is started from the third memory area before the storage of the reduced data into the third memory area is completed.

8. A video reproduction apparatus comprising:
a decoding block for decoding moving picture coded data which are subjected to a compression processing utilizing an inter-frame correlation in a time-axis direction;
a first memory area and a second memory area each of one frame, for storing video data obtained by decoding a non-bidirectional predictive frame;
a third memory area of less than one frame, for storing a part of decoded video data;
a video output processing block for transferring the video data from any of the first, second, and third memory areas to output a decoded video signal; and
a control means for controlling the operations of the decoding block, the first, second, and third memory areas, and the video output processing block; wherein
said control means performs a control such that a memory area of one frame is secured by compensating the third memory area with using an audio or sub-video input data buffer area, when performing reproduction in a temporally reverse direction or when searching for arbitrary pictures.

9. A video reproduction apparatus comprising:
a decoding block for decoding moving picture coded data which are subjected to a compression processing utilizing an inter-frame correlation in a time-axis direction;
a first memory area and a second memory area each of one frame, for storing video data obtained by decoding a non-bidirectional predictive frame, respectively;
a third memory area of less than one frame, for storing a part of decoded video data;
a video output processing block for transferring the video data from any of the first, second, and third memory areas to output a decoded video signal; and
a control means for controlling the operations of the decoding block, the first, second, and third memory areas, and the video output processing block; wherein
said control means performs a control such that a memory area of one frame is secured by compensating the third memory area with using a part of a main-video input data buffer area, when performing reproduction in a temporally reverse direction or when searching for arbitrary pictures.

10. A video reproduction apparatus as defined in claim 8, wherein
said control means performs, when a non-bidirectional predictive frame that is temporally previous by one frame is to be decoded in a case where reproduction in the temporally reverse direction or search for arbitrary pictures is performed and the picture that is currently displayed is a non-bidirectional predictive frame, a control such that a memory area which stores the decoded video data of the one-frame-previous non-bidirectional predictive frame is determined according to the total number of the picture to be outputted next and the pictures to be decoded by the time when the picture to be outputted next is decoded, and whether the picture to be outputted next is a bidirectional predictive frame or not.

11. A video reproduction apparatus as defined in claim 8, wherein
said control means performs, when a non-bidirectional predictive frame that is temporally previous by one frame is to be decoded in a case where reproduction in the temporally reverse direction or search for arbitrary pictures is performed and the picture that is currently displayed is a non-bidirectional predictive frame, a control such that the decoded video data of the one-frame-previous non-bidirectional predictive frame is copied from the memory area which stores this data to another memory area.

12. A video reproduction apparatus as defined in claim 9, wherein
said control means performs, when recovering to the normal reproduction from the reproduction in the temporally reverse direction or the reproduction of searching for arbitrary pictures, a control such that the input data in the main-video input data buffer area which is used when performing the reproduction in the temporally reverse direction or the reproduction of searching for arbitrary pictures is copied into another area in the input data buffer area.

13. A video reproduction apparatus as defined in claim 9, wherein
said control means performs, when a non-bidirectional predictive frame that is temporally previous by one frame is to be decoded in a case where reproduction in the temporally reverse direction or search for arbitrary pictures is performed and the picture that is currently displayed is a non-bidirectional predictive frame, a control such that a memory area which stores the decoded video data of the one-frame-previous non-bidirectional predictive frame is determined according to the total number of the picture to be outputted next and the pictures to be decoded by the time when the picture to be outputted next is decoded, and whether the picture to be outputted next is a bidirectional predictive frame or not.

14. A video reproduction apparatus as defined in claim 9, wherein
said control means performs, when a non-bidirectional predictive frame that is temporally previous by one frame is to be decoded in a case where reproduction in the temporally reverse direction or search for arbitrary pictures is performed and the picture that is currently displayed is a non-bidirectional predictive frame, a control such that the decoded video data of the one-frame-previous non-bidirectional predictive frame is copied from the memory area which stores this data to another memory area.
